(19) United States
(12) Patent Application Publication
(10) Pub. No.: US 2008/0242343 A1
(43) Pub. Date: Oct. 2, 2008

(54) Modeless electronic systems, methods, and devices

(75) Inventors: Eugene Koh, Brookline, MA (US); Matias Duarte, Los Angeles, CA (US)

Correspondence Address: K&L Gates LLP, STATE STREET FINANCIAL CENTER, One Lincoln Street, BOSTON, MA, 02111-2950, US

(73) Assignee: Helio, LLC, Los Angeles, CA (US)

(21) Appl. No.: 11/977,069

(22) Filed: Oct. 23, 2007

Related U.S. Application Data
(60) Provisional application No. 60/928,945, filed on May 11, 2007.
(60) Provisional application No. 60/920,299, filed on Mar. 26, 2007.

(51) Int. Cl. H04M 1/00; G06F 17/30

(52) U.S. Cl. 455/550.1; 707/3; 707/E17.014

(57) ABSTRACT

Methods and device are provided for searching and displaying informational objects using a mobile device. In more specific terms, embodiments relate to a modeless search architecture in which queries can be initiated simply by actuating an input device, such as typing on the keypad, or issuing a voice command. In one aspect, the invention relates to a mobile device for modelessly executing and displaying results of a contact query, search term or voice command. In another aspect, the invention relates to a method for performing a modeless search on a mobile device.

### CROSS REFERENCE TO RELATED APPLICATIONS

This application claims the benefit of U.S. Provisional Patent Application No. 60/920,299, filed Mar. 26, 2007 and U.S. Provisional Patent Application No. 60/928,945 filed on May 11, 2007, the entire disclosures of which are incorporated herein by reference in their entirety.

### FIELD OF THE INVENTION

The present invention relates generally to user interfaces for mobile electronic communications and, more particularly, to a device and methods for modelessly searching and displaying information using a mobile device.

### BACKGROUND OF THE INVENTION

As mobile electronic communications have proliferated, their importance has greatly increased. The volume of electronic communications, such as e-mail and other mobile communications has also greatly increased, but the presentation of such communications has not significantly changed. In particular, mobile devices tend to isolate user content in information silos accessible only by drilling down through a series of menus associated with the type of content (e.g., e-mail messages in the message area, pictures in the camera area). A user running an application or using a specific device mode must first exit the application or execute a series of steps to exit the current device mode to launch a search. In a sense, the user is locked in or constrained in their usage of the device. Such systems are tedious for mobile device users who need access to content immediately. A user interface of this type may be adequate for users of desktop computers, but not for mobile users who need to access content with minimal input.

### SUMMARY OF THE INVENTION

Embodiments of the present invention provide methods and systems for searching and displaying informational objects using a mobile device. In more specific terms, embodiments relate to a search architecture in which queries can be initiated by typing or speaking without having to explicitly change application input or device modes.

In one aspect, the present invention relates to a mobile device for modelessly executing and displaying results of a contact query or search term. In an embodiment of the present invention, the mobile device includes a processor, a storage medium containing a plurality of informational objects associated with contacts and a memory storing computer readable instructions to automatically identify a subset of the informational objects having a common contact and displaying a visual representation of each informational object in the subset in an organized fashion upon receiving a single user action.

In another aspect, the present invention relates to a method for performing a search on a mobile device. Typically, the search is performed using modeless features and processes in one embodiment. In an embodiment, the method includes energizing the mobile device such that the device is in a first operational state, entering a sequence of characters corresponding to a search query while the mobile device is in the first operational state and generating at least one search result in response to the sequence. The results of the search are displayed to the user using a screen or other output device in one embodiment. In another embodiment of the present invention, the method includes the steps of initiating a prompt state on a mobile device, entering a sequence of characters while the device is in the prompt state, processing the sequence of characters as a search query and generating at least one result in response to entering the sequence.

In yet another aspect, the invention relates to a method of performing a search on a mobile device having an output device and an input device. The method includes the steps of energizing the mobile device such that the device is in a first operational state; entering a sequence of characters, the sequence corresponding to a search query while the mobile device is in the first operational state; and generating at least one search result in response to the sequence. The sequence of characters can include alphabetical characters.

In another aspect, the invention relates to a method of performing a modeless search on a mobile device having an output device and an input device, such as a keypad. The method includes the steps of initiating a prompt state on a mobile device; entering a sequence of characters while the device is in the prompt state; processing the sequence of characters as a search query; and generating at least one result in response to entering the sequence. In one embodiment, the sequence of characters includes alphabetical characters or alphanumeric characters, symbols, or other icons or graphic elements. The method can further include the step of, if the sequence of characters is a phone number, dialing the phone number. The method can include the step of displaying the result in an organized information mode. It can also include the step of triggering an Internet capable browser to execute and display the result of the search query. In one embodiment, initiating a prompt state on a mobile device further includes the step of transitioning from an idle state to the prompt state. Initiating a prompt state on a mobile device can include the step of transitioning from an application mode to the prompt state. Further, initiating a prompt state on a mobile device can include transitioning from a device mode to the prompt state.

In another aspect, the invention relates to a method of performing a search on a mobile device. The method includes the step of initiating an idle state on a mobile device; entering a sequence of characters while the device is in the idle state; processing the sequence of characters as a search query; and generating at least one search result in response to entering the sequence. In one embodiment, the sequence of characters includes alphabetical characters.

In yet another aspect, the invention relates to a method of modelessly initiating an application on a mobile device. The method includes the steps of initiating a first state on a mobile device; entering a sequence of characters while the device is in the first state; processing the sequence of characters; and triggering a software application on the mobile device in response to entering the sequence. In one embodiment, the sequence of characters includes alphabetical characters. The first state can be selected from a group consisting of an idle state; a prompt state; an on state; and a sleep state. The software application can be selected from the group consisting of a messaging application; a GPS application; a game; a media player; a search application; and a browser. In one embodiment, at least one of the initiating steps is performed using a modeless architecture resident in storage on the mobile device.

In still another aspect, the invention relates to a mobile device that includes a processor; a storage on which resides a plurality of informational objects, wherein each informational object is associated with an attribute; and a memory for storing computer readable instructions that, when executed by the processor, cause the processor to automatically identify a subset of the plurality of informational objects associated with the attribute and, upon receiving a single user action, to display a visual representation of each informational object in the subset in an organized fashion.

In one embodiment of the invention, the mobile device implements a RAM-resident, C-compiled application that, upon receipt of alphanumeric keystrokes when the device is in an ‘idle’ state, accepts the alphanumeric input and pattern-matches against the local contact list in real-time. Simultaneously, the application offers the user a ‘submit’ softkey that, upon selection, initiates an “HTTP GET” request that passes the user-input text to an operator-controlled redirection service that passes the query string to an operator-hosted web service that performs the default search through an XML API provided by a third-party search engine, such as Yahoo!. The API then returns an XML object containing search results that the operator-hosted web service then parses and composes into presentation-layer markup language, including JavaScript-based ‘tabs’ that redirect the search request to other third-party search engines (e.g. Google, Wikipedia, Amazon.com, etc.). In one embodiment, the modeless search allows a user to locate search results selected from the group consisting of a messaging application; a GPS application; a game; a media player; a search application; and a browser.

In one embodiment, the mobile device further includes a keypad in communication with the processor for interaction by the user. In another embodiment, the mobile device is a three layer device. In still another embodiment, the mobile device includes a first and second key pad that slide relative to each other. The keypad can also be implemented as a keypad entry portion of a touch sensitive display. A search query may be modelessly initiated by typing on the keypad in one embodiment. In one embodiment, the computer readable instructions, when executed by the processor, further cause the processor to automatically trigger a search using a browser. The browser can be a browser or other suitable mobile browser. The device can be adapted to display an icon for receiving the single user action. The single user action further causes the mobile device to transition from an application mode to a first operational state in one embodiment. Also, the single user action can further cause the mobile device to transition from a device mode to a first operational state. The device can be adapted to receive the single user action from a first operational state. The single user action can include identifying a contact.

Another embodiment of the invention includes a method for performing a search on a mobile device. The method includes initiating a first operational mode on the mobile device; accepting a predetermined sequence of characters while the mobile device is in the first operational mode; launching a first task, if the predetermined sequence of characters match a predetermined set of characters; accepting a further sequence of characters while the mobile device is in the first operational mode; processing the sequence of characters as a search query; and triggering a background process on the mobile device in response to the sequence of characters.

In yet another aspect, the invention relates to a method for performing a search on a mobile device. The method includes initiating a first operational state on the mobile device; transitioning to a second operational state in response to one of a plurality of predetermined events; receiving a first voice communication while the device is in the second operational state; analyzing the first voice communication to detect a discrete voice command corresponding to a search query while the mobile device is in the second operational state; and generating at least one result in response to the search query.

In another aspect, the invention relates to a method of performing a search on a mobile device having an input device and an output device. The method includes initiating a modeless search on a mobile device in response to entry of a search term using the input device, wherein the modeless search is initiated in the absence of accessing a menu application; and displaying the search results associated with the search term using the output device.

In another aspect, the invention relates to a method of performing a search on a mobile device having an input device and an output device. The method includes the steps of initiating a modeless search on a mobile device in response to entry of a search term using the input device, wherein the modeless search is initiated in the absence of using the input device to initiate a search application; and displaying the search results associated with the search term using the output device. In one embodiment, the search application is selected from the group consisting of a browser, an icon accessible program; a file menu program; an explorer application; and a contact list directory.

In yet another aspect, the invention relates to a method of conducting a search on a wireless mobile device. The wireless mobile device having a plurality of searchable categories. The method includes the steps of performing a search in each of the plurality of searchable categories in response to only a single action of a user; and displaying search results from the search, wherein the single action of the user inputs a search term and initiates the search, wherein the search is based on the search term. In one embodiment, the mobile device has an alphanumeric keypad having at least one alphanumeric key and the single action of the user is the user pressing one of the alphanumeric keys on the alphanumeric keypad.

In still another aspect, the invention relates to a method of conducting a search on a mobile device, the mobile device is adapted to display a plurality of screens; each screen accessible from at least one of another of the plurality of screens by a link, one of the plurality of screens is a home screen. The method includes the steps of receiving a search term on the home screen; conducting a search based on the search term; displaying search results from the search, wherein each of the plurality of screens is represented by a respective tree node in a tree data structure and every link between two screens is represented by an edge between the two respective tree nodes representing the two screens, the tree data structure having a single root node, wherein the home screen is represented by the single root node. In one embodiment, the mobile device has an alphanumeric keypad having at least one alphanumeric key and a single action of the user initiates the step of conducting a search. Further, in one embodiment, the single action of the user is pressing one of the alphanumeric keys.

In one general aspect of the present invention, the mobile device can be adapted to store informational objects and for automatically identifying a subset of the informational objects having a common attribute, such as all the informational objects associated with a given contact, and, upon receiving a single user action, for displaying a visual representation of each informational object in the subset in an organized fashion. In various aspects, the informational objects may include, for example, informational object types such email messages, pictures, audio, video, or text messages. Implementations may also include an input device for selecting the informational objects, such as when a single user action is received, and wherein the mobile device is adapted to derive the common attribute from the selected informational object. Various implementations may facilitate a user's search, navigation and exploration of the informational objects through modeless operation whereby users can initiate the organized information mode, such as by typing on the keypad, from any device mode including idle.

In another general aspect of the present invention, a method of managing the display of information objects on a mobile device includes identifying a subset of information objects stored on the mobile device that have a common attribute; receiving a single user action indicative of the common attribute; and displaying the subset in an organized fashion, such as in a tabbed format. In some embodiments, the method further includes selecting the information object, deriving the common attribute or contact, and then displaying the subset organized by the common attribute or contact. In various aspects, the single user action may be received in any mode.

In another general aspect of the present invention, a computer program generates a graphical user interface that includes a visual representation of a tab and a visual representation of the informational objects associated with the tab wherein each informational object associated with the tab has a common attribute, defined by a tag or other metadata. For example, the subset of informational objects associated with the tab may be associated with the same contact. In some embodiments, the tabs may be used to organize the informational objects by informational object type, such by as email, audio, video, picture, or text messages.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a functional block diagram that illustrates the components of an exemplary system for practicing an embodiment of the present invention;

FIGS. 2A and 2B are schematic diagrams of different views that illustrate an exemplary mobile device for searching and displaying informational objects according to an embodiment of the present invention;

FIG. 3 is a flow chart that depicts a method for modelessly searching and displaying results and recommended actions according to an embodiment of the present invention;

FIG. 4 is a high-level flow diagram that illustrates modeless execution of an exemplary search term in accordance with an embodiment of the present invention;

FIG. 5 is a flow diagram that illustrates modeless execution of an exemplary phone number dialing event in accordance with an embodiment of the present invention;

FIG. 6 is a flow diagram that illustrates modeless execution of an exemplary contact query in accordance with an embodiment of the present invention; and

FIG. 7 is a high-level flow diagram that illustrates modeless execution of an exemplary voice command in accordance with an embodiment of the present invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Embodiments of the present invention relate to methods and systems for searching and displaying informational objects on a mobile device. Some embodiments relate to a look-up and dialer architecture in which contact look-up and dialing may be initiated simply actuating an input device, such as by typing into a keypad. According to such an embodiment, contacts may be immediately displayed and the results refined as successive keystrokes are received. In another embodiment, search queries may be modelessly initiated by typing into the keypad. Other embodiments of the present invention, relate to voice command integration by which contact or query look-up and dialing may be initiated simply by speaking into an active microphone. For example, an embodiment of the present invention may be used to immediately display messages in a message store that have a common characteristic, such as those sent to or from a certain person. Alternatively, a user may modelessly trigger a browser, either through keypad input or voice command, to initiate a search on the Internet for a query. In such an embodiment, the results can be displayed to the user in an organized fashion.

In the following discussion of illustrative embodiments, a “mobile device” includes, without limitation, mobile phones, remote control devices, personal digital assistants, hand-held computers, ultra-mobile personal computers, and the like. The term “softkey” includes, without limitation, a hard key without a fixed function, or alternatively, a virtual or screen button that appears on a touch screen. In either configuration, softkeys may be programmed to perform dynamic functions. The term “user” refers to an individual using a mobile device. The term “automatically” means without human intervention.

The term “idle mode” or “idle state” refers to the default device state when the mobile device is switched on or when the user is not navigating to a particular function, nor actively using a particular application. In various embodiments of the present invention, the mobile device may have different idle states. For example, a flip or slide-open mobile device may initially be in a first idle state, and upon being flipped or slid open, transition to a second idle state. In the first idle state the mobile device may not be responsive to active user input such as navigation of external keys and/or speech input. Alternatively, in the first idle state, the mobile device may be responsive to a select number of user or mobile electronic events such as, for example, activation of the embedded digital camera application program. In the second idle state, the mobile device may be ready to accept all kinds of user input including, but not limited to keypad entry and/or voice command. In some embodiments of the present invention, the mobile device may have two display screens that may each be configured to display different default screens while in the idle state.

The term “informational object” refers to information, in any form, than can be either directly or indirectly associated with an individual including, but not limited to, email, audio, video, pictures, and text messages. The term “contact,” as used herein, generally includes information that corresponds to a contact and that may be considered relevant for identifying, contacting, accessing, corresponding or communicating with the contact. More generally, a “contact” can be any information corresponding to a person or a business. The term “application mode” as used herein, generally refers to a processor or memory state, or a type of user interface or screen displayed when a user is using a particular application or software. The term “device mode” as used generally refers to a processor or memory state, or a type of user interface or screen displayed when the mobile device is in an idle state, or when a user is navigating to a menu, a specific application or function on the mobile device. The term “modeless” as used herein, generally refers to a type of interface, software, or processing state such that a user is free to perform an action without having to proactively change (e.g., by means of a hard key press) the current state, settings or modality of the mobile device. In some modeless implementations, interpretation of the various user input modalities (e.g., voice vs. text input) is still handled by independent services; however, user perception is that a single system handles all input because the user is not required to change application input or device modes explicitly before commencing input.

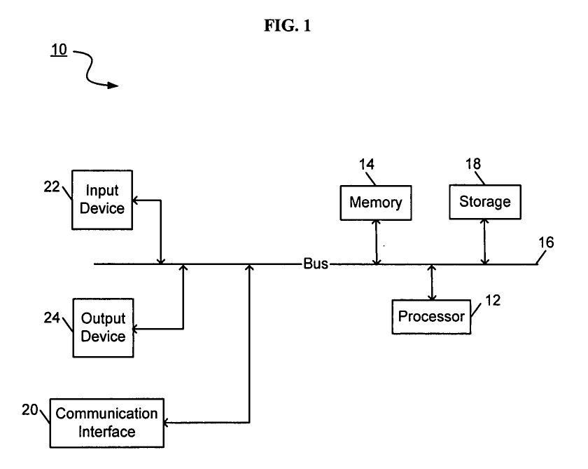

FIG. 1 is a functional block diagram that illustrates the components of an exemplary mobile device 10 for practicing an embodiment of the present invention. Mobile device 10 preferably includes a processing unit 12, a system memory 14, storage 18, a communication interface 20, an input device 22, an output device 24, and a system bus 16. System bus 16 couples system components including, but not limited to, system memory 14 to processing unit 12. The processing unit 12 can be any of various available processors.

Input device 22 may be a keyboard, thumbboard, or touchscreen (for use with a stylus) that are used to receive data from a user. In addition, input device 22 can also include a plurality of other inputs or controls for adjusting and configuring one or more aspects of the present invention including voice commands. In one preferred embodiment, a dual keyboard slider configuration is used for the mobile device. Output device 24 may be a display device, such as an LCD or LED display screen, that can display one or more display objects (not shown) such as configurable icons, buttons, input boxes, menus, tabs, softkey labels and so forth having multiple configurable dimensions, shapes, colors, text, data and sounds to facilitate operations with mobile device 10.

Communication interface 20 facilitates data exchange over a variety of wireless networks. The hardware and software necessary for connection to the communication interface 20 includes, for exemplary purposes only, internal and external components that transmit and receive data wirelessly across a plurality of standard protocols including, for example, PCS, GSM, CDMA, Bluetooth, WiFi, IrDA, WiMAX, WiBRO or through other known wireless standards.

Storage 18 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

It is to be appreciated that FIG. 1 describes software that acts as an intermediary between users and the basic resources described in mobile device 10. Such software preferably includes an operating system. The operating system, which can be resident in storage 18, acts to control and allocate resources of mobile device 10. System applications take advantage of the management of resources by the operating system through program modules and program data stored either in system memory 14 or on disk storage 18. Furthermore, it is to be appreciated that the present invention can be implemented with various operating systems or combinations of operating systems.

The computer readable medium tangibly embodies a program, functions, and/or instructions that cause the computer system to operate in a specific and predefined manner as described herein. Those skilled in the art will readily appreciate, however, that the process described below may be implemented at any level, ranging from hardware to application software and in any appropriate physical location. For example, the present invention may be implemented as software code to be executed by mobile device 10 using any suitable computer language and may be stored on any of the storage media described above, or can be configured into the logic of mobile device 10. Such software code may be executed by mobile device 10 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

In various embodiments, the invention implements a modeless architecture to receive user inputs and translate them to mobile device responses in the form of initiating different software applications. Typically, programs such as modules, libraries, and specific software applications are resident in memory that capture user inputs and regulate outputs as a function of which operational state the device is in. Keyloggers, input device tracking modules, and other applications known in the art can be used as part of a modeless architecture to respond or “wake up” when an input device is actuated. In some embodiments, a modeless architecture can be implemented in hardware such that input device actuation selectively overrides other operational modes and allows applications to be triggered, such as a search query or messaging applications that starts from a keystroke after turning the device on. Additional details relating to modeless mobile device features are described in more detail below.

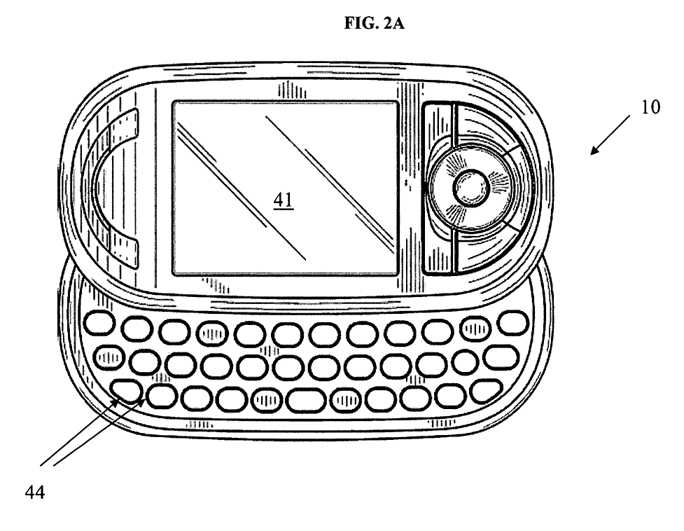

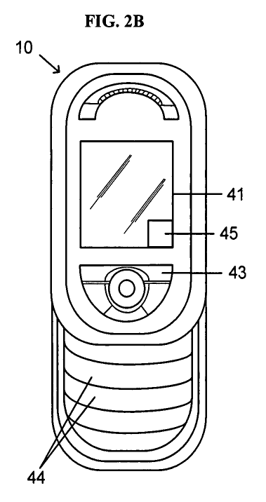

FIGS. 2A and 2B are schematic diagrams that illustrate mobile device 10 for searching and displaying informational objects according to an embodiment of the present invention. As shown the device 10 is a dual-slider keyboard device such that the two keyboards slide relative to each other. One keypad, such as shown in FIG. 2A can include a full QWERTY keyboard while the second keypad can include a numeric keypad, such as shown in FIG. 2B. That said, the modeless search and other features described herein are extendable to all mobile devices. Mobile device 10 includes an input device such as a keypad 44 with individual keys for entering characters, numbers, or symbols.

The mobile device and methods recited herein offer a significant time saving advantage and enhanced user experience by processing keystrokes from any energized state or an idle state. Thus, a user can simply type in a character string, such as “pizza,” and search results from multiple sources relating to the character search string will be displayed without having to initiate a menu based browser or other application. In a preferred embodiment, the search results are arranged in a tab-wise hierarchy such that contacts, media, internet search results, and other informational object categories are all grouped as separate tabs. As a result, key strokes and device interaction time are reduced. For the busy travel or modern device user, this enhanced experience is very desirable.

In one embodiment, as characters are entered in the device, without accessing a drop down menu of directly instancing a search program, repositories of data are exhaustively searched on the device (or on a network) relative to each character or sequence of characters entered such that if search results in one repository of data are not found another repository of data is then searched. That is, in one embodiment, if user types in the character “P,” initially all of the informational objects on the phone will be identified that start with “P” in a particular category of files. For example, if the user initiated the search from a contacts or email interface, the first set of search results can be configured to be performed relative to contacts. Similarly, if the user was listening to music, the first set of search results can be configured to be specific to media files. However, in another embodiment, if the user continues to enter characters, such that the term “Pub” is entered, and no informational objects include those characters, the device can be configured to automatically search a network, such as the Internet, to provide additional sources of information to the user, such as the location of local entertainment spots.

In a preferred embodiment, keypad entry is used to initiate a modeless search. However, as shown in FIG. 2B, a softkey label 45 is drawn on a display screen 41 adjacent to softkey 43, so that the function and action associated with the softkey may be readily defined and re-defined according to the particular state of the user interface.

When pressed or otherwise activated, a key on a keypad 44 or a softkey 43 character display causes mobile device 10 to display in an organized fashion related informational objects cached on mobile device 10 and/or associated with a host computer system. Informational objects may be organized through the use of metadata originally associated with an object or specified by either the user or the system for organizational purposes. According to such an embodiment, mobile device 10 is configured to automatically sort and cache informational objects after a search using a pre-defined scheme. An example of such a pre-defined scheme may be one where informational objects are sorted and cached by contact.

Although the embodiments illustrated herein typically use a keypad, such as a QWERTY keypad or a numeric keypad, as a mechanism for initiating a search, virtually any mechanism configured to capture a user command such as, for example, soft keys, voice command, touch screen or keypad navigation, whether displayed or not, can be used to initiate a search or contact look-up without departing from the principles of the invention. Additionally, embodiments of the present invention allow users to initiate a search or contact look-up from device modes including and other than an idle state.

In an embodiment of the present invention, mobile device 10 is configured to allow users to modelessly initiate a search or contact look-up from idle or any other device mode or application mode. That is, by entering a combination of keys corresponding to a particular contact or search term, a modeless query is run by the device. Alternatively, the user of mobile device 10 may issue a voice command that is picked up by an active built-in or external microphone. In such an embodiment, mobile device 10 automatically initiates a background process to perform a search or contact look-up regardless of the current operational mode or processing state, as soon as a first keystroke or voice command is received.

In an embodiment, the background search process is automatically refined as successive keys are pressed by a user. Thus, all that is necessary for a busy user to find what he or she is looking for is (1) powering the mobile device 10 coupled with then (2) keying or otherwise entering a search string. Once the device is powered, the input devices allow modeless software application initiation. Thus, accessing menus and fumbling around looking for particular icons is not required in some embodiments. In another embodiment of the present invention, a busy user of mobile device 10 may immediately find information simply by providing a voice input. In such an embodiment, the background process automatically performs a search or contact look-up regardless of the operational mode or processing state of mobile device 10.

Mobile device 10 may present the results of a contact query or voice command to users by entering an organized information mode. For example, the user interface can include tabs that display informational objects associated with the contacts or a particular search query. In one embodiment, the tab displays informational objects sorted by a common action attribute (e.g., communications with contact, “Kevin”) rather than by file type. Although the specifics of displaying each search result can vary with a user's preference, the subset of related informational objects are presorted and displayed by the date received. In addition, a user may enter a character string, such as a string of alphabetical characters, numbers, symbols, or combinations thereof using an input device, such as a key pad. In response, the mobile device will receive and process the input string as a search string in one embodiment without the user having to specifically initiate a search application or browser. In one embodiment, the search results can be displayed in any number of user friendly hierarchical or direct formats as may be desirable to the user.

In an embodiment of the present invention, users of mobile device 10 may also view the results of a contact query or voice command in a tiered hierarchy. In such an embodiment, each tier may represent results from a different data source. For example, in a four tier hierarchy, search results may be presented under the headings or informational object groupings, “Contacts,” “Device files,” “Authorized network content,” and “Internet results.” Mobile device 10 may also present results in each tier in many other forms known to those skilled in the art such as, for example, tabbed or list format.

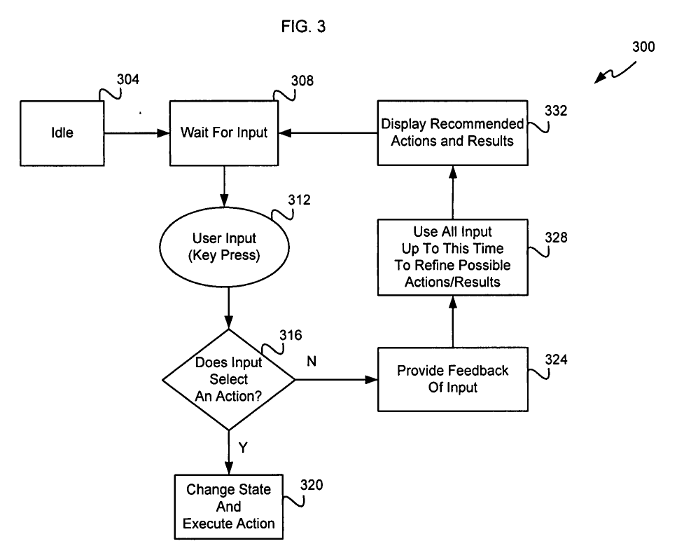

FIG. 3 is a flow chart illustrating a method for modelessly searching and displaying results and recommended actions in accordance with an embodiment of the present invention. As shown in step 304, mobile device 10 is initially in idle mode. In an embodiment of the present invention, mobile device 10 may be in any operational state including a device mode or application mode other than idle. Thus, a user of mobile device 10 may immediately dial a number, issue a voice command, initiate a search or look-up a contact without having to exit the current application or device mode. Further, aspects of the invention allow a user to modelessly search and access other messaging features and applications without having to use a conventional nested drop down menu. As a result, some of the features disclosed herein obviate the need to search for an icon or drop down menu when a user wishes to initiate a particular application on the device, such as a search query or a messaging a contact.

In one embodiment of the invention, the mobile device implements a RAM-resident, C-compiled application that, upon receipt of alphanumeric keystrokes when the device is in an ‘idle’ state, accepts the alphanumeric input and pattern-matches against the local contact list in real-time. Simultaneously, the application offers the user a ‘submit’ softkey that, upon selection, initiates an “HTTP GET” request that passes the user-input text to an operator-controlled redirection service that passes the query string to an operator-hosted web service that performs the default search through an XML API provided by a third-party search engine, such as Yahoo!. The API then returns an XML object containing search results that the operator-hosted web service then parses and composes into presentation-layer markup language, including JavaScript-based ‘tabs’ that redirect the search request to other third-party search engines (e.g. Google, Wikipedia, Amazon.com, etc.). The steps shown in FIG. 3 can be executed in real time for each keystroke entered by the user and/or the device as appropriate. In step 308, mobile device 10 is alerted to prompt state to indicate readiness to accept a user input. Those skilled in the art will appreciate that mobile device 10 may recognize several other user actions as implying a user's desire to input a contact or search query and have the mobile device 10 respond with a modeless search. Again, the modeless operation of the device is not limited to search queries. For example, the device can be programmed to recognize commands from different device modes. Thus, typing “GPS” may modelessly query a GPS system to provide the user with a location. In one embodiment, the modeless features described herein can be integrated with a generalized graphic user interfaces associated with all of the messaging applications resident on the mobile device as disclosed in the co-pending U.S. Patent Application Ser. No. 60/925,963, filed Apr. 23, 2007, entitled “Aggregated Messaging, Contacts, and Mail Interface, Systems and Methods”, the disclosure of which are herein incorporated by reference in their entirety.

In an embodiment of the present invention, the prompt state of mobile device 10 does not prevent other user commands specific to the current device mode or application mode from functioning. In addition, inaction for a predetermined amount of time may cancel the prompt state and seamlessly return the user interface of mobile device 10 to its original idle, device mode or application mode.

In step 312, mobile device 10 accepts user input when the user presses a key. As shown in step 316, mobile device 10 then determines if the keystroke constitutes a user action. Keystrokes interpreted as user actions may include pressing the “SEND” key, “Center Select Key (“CSK”), “Return” key on a QWERTY keypad, or any other special key known to those skilled in the art without departing from the principles of the invention. In an embodiment of the present invention, users of mobile device 10 may also confirm selection of an action by any other standard way known to those skilled in the art such as voice command, touch screen and/or navigating with a thumbstick or keypad.

As shown in step 320, when a user action is selected, mobile device 10 may transition to a different operational state and/or launch an application, execute a predetermined task, or perform substantially any of a plurality of related functions depending on the nature of the user action.

In step 324, if the keystroke entered by the user does not constitute a user action, mobile device 10 may automatically provide feedback based on the input entered up to that point. In step 328, mobile device 10 uses substantially all the input entered to refine results and actions available to the user. Such results may include, without limitation, a list of prior search terms cached in a local store, a list of contacts sorted in an organized manner or a list of contacts sorted by phone number based on the characters entered. Actions may include, without limitation, dialing a number, dialing a contact from the contacts list, triggering a browser to search the Internet or saving the information entered in a local store. Those skilled in the art will readily appreciate that many other results and actions other than those mentioned here may be made available to the user.

As shown in step 332, the results and actions are displayed by the user interface of mobile device 10. The user of mobile device 10 may view the results, select an action or continue to enter further keystrokes.

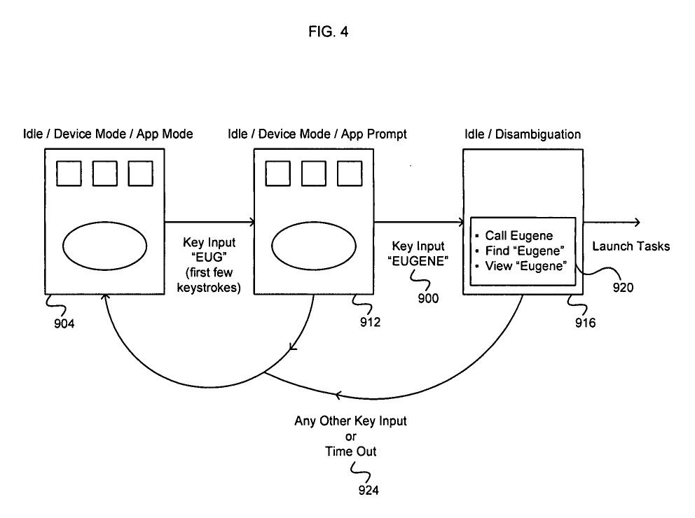

FIG. 4 is a high-level flow diagram that illustrates modeless execution of an exemplary contact query or search term 900 in accordance with an embodiment of the present invention. A busy user of mobile device 10 may need to immediately find contact information of a friend, for example, Eugene. In an embodiment of the present invention, mobile device 10 may initially be in idle or any other device mode or application mode as shown in display screen 904. In another embodiment, the user may be engaged in a conversation on mobile device 10 and need to simultaneously look up contact information for Eugene. In such a situation, initiation of a modeless search for Eugene's contact information using minimal keystrokes is desirable. As shown, the user may initiate the search simply by keying in the first few letters “EUG” of contact query or search term 900, “EUGENE” into mobile device 10 at any time regardless of the current operational state or mode. Once the prompt state is established as a result of keying in the first few letters, the user may proceed to enter the entire contact query or search term 900.

In display screen 912, mobile device 10 is alerted to prompt state while continuing to remain in or transitioning from idle or any other device mode or application mode. The integration of modeless keystroke input analysis and results into the current idle mode or other device mode or application mode do not prevent other user commands specific to the current device mode or application mode from functioning. In an embodiment of the present invention, mobile device 10 may implement “suggest” technology to aid the user by providing a list of likely search queries. In such an embodiment, mobile device 10 offers “auto complete” options based on several factors such as user history, real-time lookups in a local phonebook, favorites modules, “buddy lists” and related historical search queries aggregated among all users of a mobile search platform. Mobile device 10 may further evaluate in real time, the extent to which it offers such suggestions based on a number of other factors including a “confidence score” provided to minimize annoying user experience.

In display screen 916, the user of mobile device 10 may be presented with an interactive disambiguation menu 920. The user may launch a number of tasks related to the contact or search term 900 from the menu 920. For example, the user may opt to call Eugene, trigger a search on the Internet for “Eugene,” or view Eugene's information in the organized information mode. During this period, mobile device 10 may continue to remain open to a limited number of other user commands specific to the original idle, device mode or application mode. Any user action 924 that is not interpreted as continued interaction with the menu 920 may cancel the disambiguation process and seamlessly transition the user interface of mobile device 10 to the original idle, device mode or application mode. Only when the user has finally confirmed the keystroke disambiguation selection is a new operational mode or processing state established and the selected task launched.

In an embodiment of the present invention, mobile device 10 is configured to allow a user to execute a contact query or search string while mobile device 10 is in a first operational state. Mobile device 10 may enter the first operational state when it is initially energized or when the user exits an application or a specific device mode. A user may enter a sequence of characters corresponding to the contact query or search string while mobile device 10 is in first operational state. Mobile device 10 may respond by generating search results, or in case of disambiguation, menu 920 prompting user to launch a relevant task.

In an embodiment of the present invention, the mechanism for initiating a search may include typing on the keypad or dialing the number of a particular contact. For example, a user of mobile device 10 may input or otherwise identify a contact so that informational objects associated with the contact will be displayed. A contact may be input using input device 22 or otherwise identified in a number of ways known to those skilled in the art without departing from the principles of the invention. In an embodiment relating to keypad input, a search may begin as soon as the first key entry is received, and is refined as successive keys are pressed by the user conducting the search. Thereby, the database on the mobile electronic device can be searched to locate and return individuals whose names or data match the search term.

For example, to display information related to Kevin, the user may input “538,” which corresponds to “kev” on the keypad of mobile device 10. Mobile device 10 may be configured to identify contacts related to one or more informational objects stored on mobile device 10. If more than one contact matches “kev,” mobile device 10 may display a list of the matching contacts from which the user may choose. In one embodiment, the modeless search is configure to process sequences of letters as first and last initials. Thus, in one particular embodiment, JD may yield “John Doe” and “John Dough” as search results.

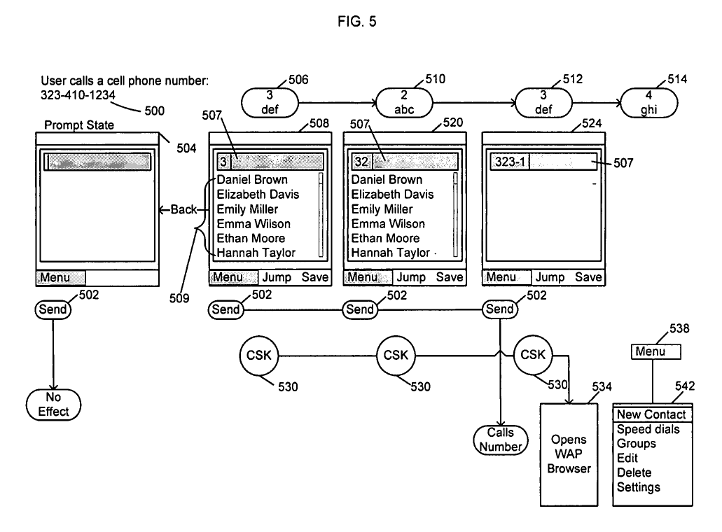

FIG. 5 is a high-level flow diagram that illustrates modeless processing of a phone number 500 entered by a user in accordance with an embodiment of the present invention. In many situations, the user of mobile device 10 may need to look up or dial a contact with minimal keystrokes. This is true particularly when the user is extremely busy or faced with an immediate emergency. For example, the user of mobile device 10 may wish to display information related to exemplary phone number 500, “323-410-1234” while engaged in an important business activity. In such a situation, the user may activate mobile device 10 and immediately key in phone number 500 to initiate the modeless query for information associated with that phone number.

In an embodiment of the present invention, mobile device 10 may initially be in stand-by or locked mode. In such an embodiment, mobile device 10 may switch to the prompt state by detecting a variety of user actions known to those skilled in the art, such as, opening a flip or slider, sliding a key lock switch, pressing and holding a keyguard release key combo or onscreen buttons, lifting mobile device 10 out of a holder, orienting mobile device 10 in a particular way or holding mobile device 10 up to the user's face. As shown in display screen 504, mobile device 10 switches to prompt state. In this state, mobile device 10 may limit user commands or actions available to the user. For example, as shown, pressing “SEND” button 502 in the prompt state has no effect.

When the user of mobile device 10 enters the first digit 506 of phone number 500, a background process is initiated to operate on input 507. As shown in display screen 508, mobile device 10 displays a list of contacts 509, sorted by a common attribute established by the background process. When successive keystrokes 510, 512 and 514 are entered, the background process is refined. Accordingly those skilled in the art will readily appreciate that the list of contacts 509, search results or actions available to user may be correspondingly refined as shown in display screens 520 and 524. At any time, the user of mobile device 10 may dial the number entered up to that point by pressing the “SEND” button 502. The user may also press center select key 530 to trigger a WAP browser 534 to initiate a search on the Internet. Alternatively, the user of mobile device 10 may press “Menu” button 538 as shown to view a list of actions 542 that may be performed on phone number 500 or a specific contact selected from the list of contacts 509.

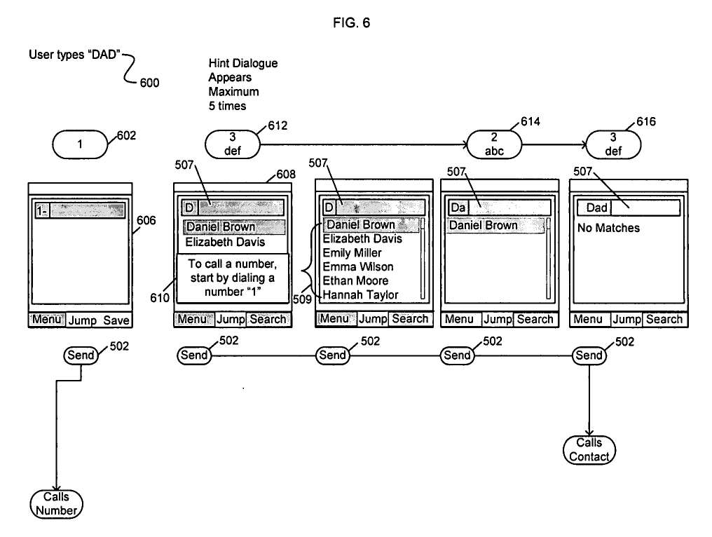

FIG. 6 is a high-level flow diagram that illustrates modeless execution of an exemplary contact 600 in accordance with an embodiment of the present invention. As shown, contact query 600, “DAD,” is keyed into mobile device 10. In such an embodiment, a user may initiate this process at any time regardless of whether mobile device 10 is in idle or any other device mode or application mode by simply pressing a key other than “1” in the keypad. According to such an embodiment, the user of mobile device 10 may dial “1” 602, to begin dialing a number as shown in display screen 606 and pressing the “SEND” button 502. In an embodiment of the present invention, a hint dialogue 610 may appear to guide the user in this aspect as shown in display screen 608. In alternate embodiments of the present invention, hint dialogue 610 may appear a certain maximum number of times.

When the user enters the first character 612 of contact query 600, mobile device 10 automatically displays a list of contacts 509, sorted by a common attribute based on the input 507. When successive keystrokes 614 and 616 are entered, list of contacts 509 is refined. As shown, the user of mobile device 10 may dial the contact 600 by pressing the “SEND” button 502.

In addition to the features recited above, in one embodiment, a mobile device search operation can be configured to vary as a function of whether the mobile device is in landscape or portrait orientation. That is, device orientation can change how device inputs are processed. Specifically, in one embodiment, starting a search in landscape mode or portrait mode generates a plurality of search results that can include, but are not limited to speed dialer search results, contact search results; menu search results, and web search results. The order of these search results can be programmed to vary as a function of device orientation. In one embodiment, these results are arranged in individual tabbed pages. Thus, if user types the “U” the results given may include speed dialer results that begin with the number 7 (for a keypad where the “U” and “7” are depicted on the same key), menus of applications that start with “U,” contacts having last names that start with “U,” or other records or items including the character “U”.

Further, different rules and device properties can be configured with respect to how search results are given. For example, in one embodiment, after a third character is entered as part of a modeless input, the text string entered by the device user is treated as a web search. However, triggering after the third character is only one example and triggering a particular type of searching can be based on N characters being entered in some embodiments.

In the example given above, when the user types “Uma” a web search through a prescribed search engine or engines on the term Uma would also be initiated. This type of rule based input processing is desirable because as more characters are being typed, there is a greater likelihood that the device user may be interested in a web search in contrast with holding one number key to trigger a smart dialing event.

Another example of logic used to enhance the user experience with modeless search can be found in enhancing the functionality of the speed dialer in the search context. In some device embodiments the numbers 2-99 can be used as speed dialer entries. Thus, entering one entry from this list of numbers causes a phone number mapped to that number to be dialed automatically or displayed for dialing. In one embodiment, the amount of time a number is held in an actuated state serves as a trigger for dialing the associated number. However, in the event a user did not hold a numeric key for the requisite period of time, in one embodiment, since the device may treat this key press as a search, one entry displayed, such as the first search result, would be the speed dial contact associated with that number. This follows because in many situations this is likely the outcome a user would have intended if they made a mistake when attempting to speed dial.

As discussed above, the implementation of modeless search described herein facilitates a menu search approach for using the device without interacting with the features of a particular user interface. Thus, if a user wants to access music or games on their device, they can simply type the name of the game or the song and the search results are presented to the user. Clicking or otherwise selecting the search results initiates the game or plays the song. Accordingly, each search result can be activated from the search menu to trigger its functionality. This menu based searching for content and applications enhances the functionality of the mobile device and speeds access for the user.

Another feature implemented in one embodiment of the device is the ability to dial a phone number in QWERTY mode in a landscape orientation without using an alt or shift key. In one embodiment of the invention, if you press an alt, shift, or other function key and then dial numbers are entered as opposed to the letters. However, in an alternative embodiment, the device input processing methods are configured such that typing in the numbers with these QWERTY keys displays the text string (i.e. the symbols or alphabet keys corresponding to the numbers on keypad), but it also gives the user the ability to dial the number by pressing send.

For example, in some device embodiment the letter keys Q through P also correspond to the numbers 1 through zero, such that the numbers are entered using an alt or shift key. In one embodiment, the need for a shift, alt or other chord style entering of numbers is obviated as part of a smart dialer implementation. As part of this implementation, in one embodiment, if a user attempts to dial a number using the QWERTY keys for a character sequence with which it does not have an associated number, then the send and/or dial prompt is removed. Accordingly, in such an embodiment, the further option of dialing a number in response to QWERTY sequence is removed from the display. However, the ability to dial a phone number using a QWERTY orientation allows users to operate the device based on their own interaction style and preferences.

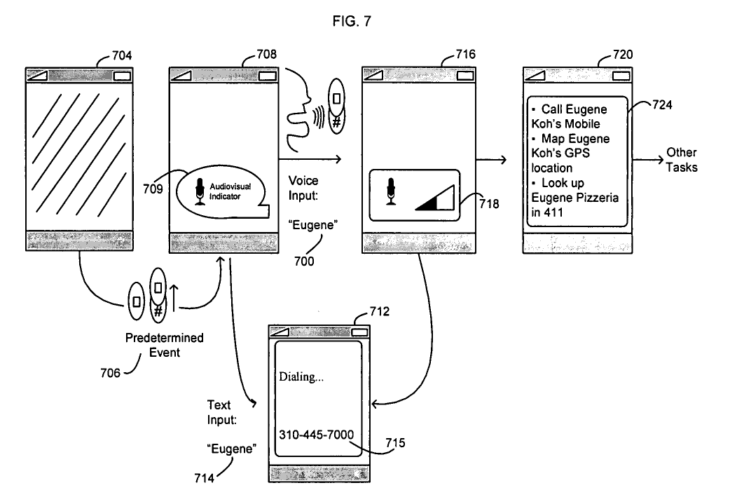

FIG. 7 is a high-level flow diagram that illustrates modeless execution of an exemplary voice command 700 in accordance with an embodiment of the present invention. A user of mobile device 10 may need to immediately dial a friend, for example, Eugene or map his geographic location by GPS. In another embodiment of the present invention, the user may be interacting with an embedded software application on mobile device 10 and need to quickly find Eugene's contact information without exiting the application. In such situations, the user can immediately issue voice command, “Eugene” 700 into an active built-in or peripheral microphone connected to mobile device 10. As shown, mobile device 10 can initially be in idle or any other device mode or application mode at user interface state 704.

In some embodiments, mobile device 10 may reach user interface state 704 when it is powered on and registered on a carrier network. In user interface state 704, mobile device 10 triggers an appropriate idle mode embedded operating system. In an embodiment of the present invention, the embedded operating system handles various mobile electronic events that occur in the ordinary course of operation of mobile device 10 such as receipt of incoming calls, e-mail, text, pictures or video messages.

In an embodiment of the present invention, the embedded operating system in user interface state 704 polls for the occurrence of a predetermined event 706 at regular intervals, for example, at intervals of 500 ms. In another embodiment, the mobile device includes an “always on” voice capture application that is responsive to one or more users of the mobile device. The always on functionality may be paired with noise cancellation hardware and software and a user enrollment routine to prevent false triggering.

Predetermined event 706 may be one or more of a plurality of user actions other than the traditional mode selection mechanism of pressing a hard key (keypad input or dedicated button), such as: flipping or sliding open mobile device 10, detecting an active microphone, energizing the mobile device, releasing a ‘key guard’, orienting mobile device 10 in a particular way (e.g., towards the user's face), lifting or releasing mobile device 10 from a physical holder, and other events associated with the ‘opening’ of a mobile device.

In another embodiment of the present invention, mobile device 10 may transition to user interface state 708 by detecting the occurrence of predetermined event 706. For example, the embedded operating system in user interface 704 may transition mobile device 10 to user interface state 708 on detection of an active external microphone, such as on a bluetooth headset or wired headphones. The embedded operating system in user interface state 704 may also poll an on-board proximity sensor for any activity known to those skilled in the art such as near-proximity or active touch to the microphone area of mobile device 10 established by, for example, a digital charge-transfer integrated circuit.

In user interface state 708, mobile device 10 may implement user interface elements such as an audiovisual indicator 709 to alert the user that voice command 700 may be issued at any time. In addition, mobile device 10 continuously monitors the active microphone (built-in or peripheral) to identify the beginning of input speech. In an embodiment of the present invention, mobile device 10 may also listen for ordinary keypress events. Those with ordinary skill in the art will readily appreciate that exemplary mobile device 10 may also recognize several other actions as implying a user's desire to input a query and have mobile device 10 respond with a modeless search or activity.

In an embodiment of the present invention, mobile device 10 may transition to user interface 712 when the user enters a text input 714 or simply dials a telephone number 715 on the keypad. In another embodiment of the present invention, mobile device 10 may transition to user interface state 716 when voice command 700 is detected. In such an embodiment, the user of mobile device 10 may cancel the current recording at any time and transition to user interface state 712 to process further commands using ordinary keypad input. In an embodiment of the present invention, mobile device 10 may implement visual user interface elements such as a graphical display of input dB level 718 in user interface state 716. In many embodiments, mobile device 10 may implement software or hardware techniques to improve performance in noisy environments. Such techniques may include, for example, adaptive noise cancellation methods and/or endpointing algorithms employing “barge-in” detection to identify the start and end of speech even though it may be overwhelmed by background noise.

In some embodiments, mobile device 10 may record voice command 700 in a standard compressed format such as, for example, Adaptive Multi-Rate (AMR), Qualcomm PureVoice (QCELP), Advanced Audio Coding (AAC) and/or other standard formats. Upon the completion of voice command 700, mobile device 10 may deliver the standard format recording to a network-based automated speech recognizer (ASR). In alternate embodiments of the present invention, mobile device 10 may selectively forward such recordings to the network-based ASR or process the recording locally with the help of embedded automatic speech recognition software.

In user interface state 720, the user of mobile device 10 may be presented with an interactive disambiguation menu 724. The user may launch a number of tasks related to voice command 700 from the menu 724. For example, the user may call Eugene by transitioning to user interface state 712, map Eugene's location using GPS, or view information related to Eugene Pizzeria on 411 look-up. The user of mobile device 10 may also cancel the disambiguation process at any time and return to the original idle user interface state 704.

Those of ordinary skill in the art will readily appreciate that mobile device 10 is exemplary only and that the present invention can operate within a number of different mobile devices. Furthermore, various embodiments of the present invention described above may be implemented at any level, ranging from hardware to application software and in any appropriate physical location or operating system.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1. A method of performing a search on a mobile device, comprising:
initiating an idle state on a mobile device;
entering a sequence of characters while the device is in the idle state;
processing the sequence of characters as a search query; and
generating at least one search result in response to entering the sequence.

2. The method of claim 1 wherein the sequence of characters comprises alphabetical characters.

3. The method of claim 1 further comprising the step of, if the sequence of characters is a phone number, dialing the phone number.

4. The method of claim 1, further comprising the step of displaying the at least one search result in an organized information mode.

5. The method of claim 1 wherein the idle state is selected from a group consisting of a prompt state; an on state; and a sleep state

6. A mobile device comprising:
a processor;
a storage on which resides a plurality of informational objects, wherein each informational object is associated with a contact; and
a memory for storing computer readable instructions that, when executed by the processor, cause the processor to automatically identify a subset of the plurality of informational objects associated with the contact and, upon receiving a single user action, to display a visual representation of each informational object in the subset in an organized fashion.

7. The mobile device of claim 6, further comprising a keypad in communication with the processor for interaction by the user.

8. The mobile device of claim 7, wherein the keypad is implemented as a keypad entry portion of a touch sensitive display.

9. The mobile device of claim 7, wherein a search query may be modelessly initiated by typing on the keypad.

10. The mobile device of claim 6 wherein the single user action further causes the mobile device to transition from an application mode to a first operational state.

11. The mobile device of claim 6 wherein the single user action further causes the mobile device to transition from a device mode to a first operational state.

12. A method of performing a search on a mobile device having an input device and an output device, comprising:
initiating a modeless search on a mobile device in response to entry of a search term using the input device, wherein the modeless search is initiated in the absence of accessing a menu application; and
displaying the search results associated with the search term using the output device.

13. The method of claim 12, further comprising the step of displaying the at least one search result in an organized information mode.

14. The method of claim 12, wherein the modeless search allows a user to locate search results selected from the group consisting of a messaging application; a GPS application; a game; a media player; a search application; and a browser.

15. The method of claim 12 wherein the search term comprises a sequence of alphanumeric characters.

16. A method of conducting a search on a mobile device, the mobile device having a plurality of searchable categories, the method comprising the steps of:
performing a search in each of the plurality of searchable categories in response to a single action of a user; and
displaying search results from the search,
wherein the single action of the user inputs a search term and initiates the search, wherein the search is generated in response to the search term.

17. The method of claim 16 wherein the mobile device has an alphanumeric keypad having at least one alphanumeric key and the single action of the user is the user pressing one of the alphanumeric keys on the alphanumeric keypad.

18. A method of conducting a search on a mobile device, the mobile device is adapted to display a plurality of screens, each screen accessible from at least one of another of the plurality of screens by a link, one of the plurality of screens is a home screen, the method comprising the steps of:
receiving a search term on the home screen;
conducting a search based on the search term;
displaying search results from the search,
wherein each of the plurality of screens is represented by a respective tree node in a tree data structure and every link between two screens is represented by an edge between the two respective tree nodes representing the two screens, the tree data structure having a single root node, wherein the home screen is represented by the single root node.

19. The method of claim 18 wherein the mobile device has an alphanumeric keypad having at least one alphanumeric key and a single action of the user initiates the step of conducting a search.

20. The method of claim 19 wherein the single action of the user is pressing one of the alphanumeric keys.
